(19) United States
(12) Patent Application Publication
(10) Pub. No.: US 2025/0121617 A1
(43) Pub. Date: Apr. 17, 2025

(54) RECORDING DEVICE

(71) Applicant: SEIKO EPSON CORPORATION, Tokyo (JP)

(72) Inventors: Takuto TANAKA, SHIOJIRI-SHI (JP); Akiho SESHIMOTO, SHIOJIRI-SHI (JP); Yoshihisa SAKA, SHIOJIRI-SHI (JP); Koji MIGITA, MATSUMOTO-SHI (JP)

(21) Appl. No.: 18/917,535

(22) Filed: Oct. 16, 2024

(30) Foreign Application Priority Data
Oct. 17, 2023 (JP) 2023-178756
May 15, 2024 (JP) 2024-079763

(51) Int. Cl. B41J 25/304; B41J 25/34; B41J 29/02; B41J 29/13

(52) U.S. Cl. CPC B41J 25/304; B41J 25/34; B41J 29/02; B41J 29/13

(57) ABSTRACT

It includes a liquid ejection section movable in a first movement direction, a mount section including a mounting space in which a liquid accommodation body that was inserted from an opening section is attachable; a fixed frame; a restriction member that is attachable to and detachable from the frame and is configured to restrict movement of the liquid ejection section in the first movement direction by being attached to the frame; a displacement member configured to, by the restriction member being attached to the frame, be displaced to a restricting position at which the displacement member, together with the restriction member, restricts movement of the movement section in movement direction, wherein the restriction member is positioned in the mounting space when the restriction member is in a restricted state in which the restriction member restricts movement of the liquid ejection section.

The present application is based on, and claims priority from JP Application Serial Number 2023-178756, filed Oct. 17, 2023, and JP Application Serial Number 2024-079763, filed May 15, 2024, the disclosures of which are hereby incorporated by reference herein in their entirety.

### BACKGROUND

### 1. Technical Field

The present disclosure relates to a recording device such as a printer.

### 2. Related Art

For example, JP-A-2015-20356 discloses a printing device as an example of a recording device. The printing device prints an image by ejecting ink, which is an example of a liquid, onto a sheet, which is an example of a medium, from a print head, which is an example of a liquid ejection section. The print head is mounted on a carriage that is reciprocally movable along a carriage rail.

The carriage may move due to shocks during transportation. For this reason, the carriage is fixed by a restriction member during the transportation in the printing device.

The restriction member of the JP-A-2015-20356 is prevented from being forgotten to be removed by making a part of the restriction member protrude from the cover in the state that the restriction member is attached to the carriage. However, since the restriction member of JP-A-2015-20356 protrudes to the outside of the printing device, there is a risk that the member may come into contact with something and come off during transportation.

### SUMMARY

A recording device that solves the above-described problem includes: a movement section configured to move in a movement direction; a mount section including a mounting space in which an attachment member configured to attach to and be inserted from the opening section; and a restriction member that is attachable to and detachable from the movement section and is configured to restrict movement of the movement section in the movement direction by being attached to the movement section, wherein the restriction member is positioned in the mounting space when the restriction member is in a restricted state in which the restriction member restricts movement of the movement section.

A recording device that solves the above-described problem includes: a movement section configured to move in a movement direction; a mount section including a mounting space in which an attachment member that was inserted from an opening section is attachable; a fixed frame; a restriction member that is attachable to and detachable from the frame and that is configured to restrict movement of the movement section in the movement direction by being attached to the frame; and a displacement member configured to, by the restriction member being attached to the frame, be displaced to a restricting position at which the displacement member, together with the restriction member, restricts movement of the movement section in movement direction, wherein the restriction member is positioned in the mounting space when the restriction member is in a restricted state in which the restriction member restricts movement of the movement section.

### BRIEF DESCRIPTION OF THE DRAWINGS

FIG. 1 is a perspective view of a recording device according to the first embodiment.

FIG. 2 is a schematic diagram showing an internal configuration of a recording device.

FIG. 3 is a side view of a first drive section.

FIG. 4 is a rear view of a holder.

FIG. 5 is a perspective view of a holder.

FIG. 6 is a perspective view of the first restriction member.

FIG. 7 is a front view of the first restriction member in the attachment/detachment posture.

FIG. 8 is a front view of a first restriction member on the way of rotation.

FIG. 9 is a front view of the first restriction member in the mounting posture.

FIG. 10 is a perspective view of a cassette.

FIG. 11 is a perspective view of a first restriction member stored in the storage section.

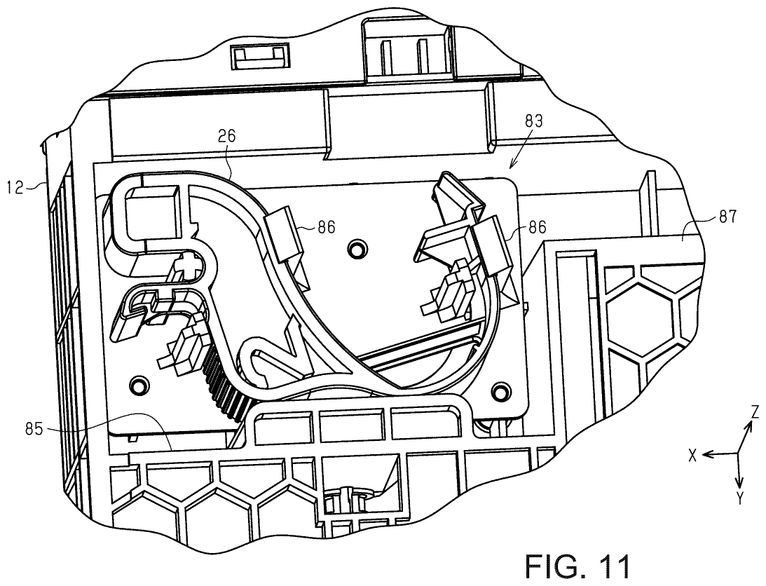

FIG. 12 is a perspective view of a displacement member in the recording device according to the second embodiment.

FIG. 13 is an enlarged view of the F13 portion in FIG. 12.

FIG. 14 is a front view of the first restriction member and the displacement member in the attachment/detachment posture.

FIG. 15 is a front view of the first restriction member and the displacement member on the way of rotation.

FIG. 16 is a perspective view of a first restriction member and a displacement member.

FIG. 17 is a front view of the first restriction member and the displacement member in the mounting posture.

### DESCRIPTION OF EMBODIMENTS

### First Embodiment

Hereinafter, a first embodiment of a recording device will be described with reference to the drawings. The recording device is, for example, an inkjet type printer which performs recording by ejecting ink, which is an example of a liquid, onto a medium such as paper sheet, fabric, vinyl, a plastic component, or a metal component.

In the drawings, assuming that a recording device 11 is placed on a horizontal plane, the direction of gravity is indicated by a Z-axis, and directions along the horizontal plane are indicated by an X-axis and a Y-axis. The X-axis, the Y-axis, and the Z-axis are orthogonal to each other. In the following description, a direction parallel to the X-axis is also referred to as width direction X, a direction parallel to the Y-axis is also referred to as depth direction Y, and a direction parallel to the Z-axis is also referred to as vertical direction Z.

### Recording Device

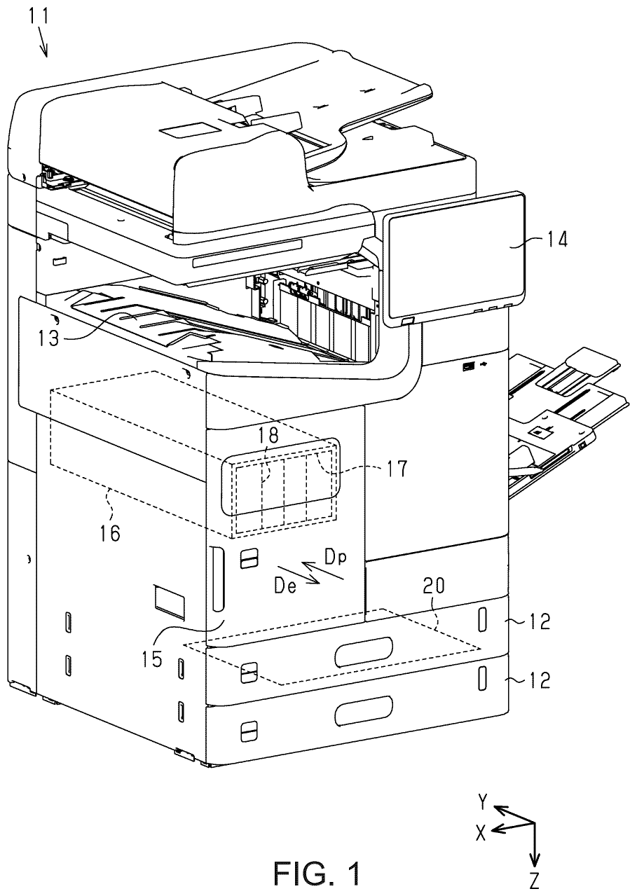

As shown in FIG. 1, the recording device 11 may include a cassette 12, a stacker 13, an operation panel 14, and a cover 15. The recording device 11 includes a mount section 16. The mount section 16 has an opening section 17. A liquid accommodation body 18, which is an example of an attachment member, can be mounted on the mount section 16.

The recording device 11 may include a plurality of cassette 12. The cassette 12 accommodates a medium 20. The cassette 12 may accommodate a bundle of medium 20 before recording. The stacker 13 receives the recorded medium 20. The operation panel 14 is, for example, a touch panel for operating the recording device 11. The operation panel 14 may be provided facing the front of the recording device 11.

The cover 15 may be displaced between a closed state shown in FIG. 1 and an open state (not shown). The cover 15 may be provided on the front of the recording device 11. In the closed state, the cover 15 covers the opening section 17. In the open state, the cover 15 does not cover the opening section 17. In the open state, the cover 15 exposes the opening section 17.

The opening section 17 may be opened toward the front of the recording device 11. The liquid accommodation body 18 is inserted from the opening section 17. The liquid accommodation body 18 is configured to be inserted from the opening section 17 when the cover 15 is in the open state.

### Internal Configuration

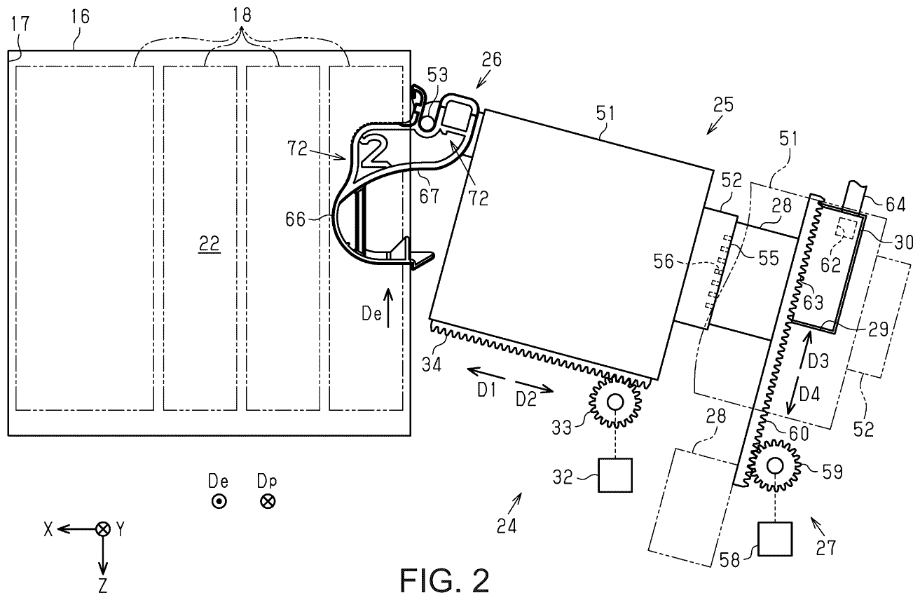

As shown in FIG. 2, the mount section 16 may have a mounting space 22. The liquid accommodation body 18 inserted from the opening section 17 is configured to be mounted in the mounting space 22. A plurality of liquid accommodation bodies 18 may be mountable on the mount section 16. Four liquid accommodation bodies 18 can be mounted side by side in the width direction X in the mount section 16 of the present embodiment.

The liquid accommodation body 18 can accommodate liquid. The liquid accommodation body 18 is mounted on the mount section 16 by being inserted from the opening section 17 toward the back of the mount section 16. At this time, the liquid accommodation body 18 moves in the insertion direction Dp which is an example of the first direction. In other words, the liquid accommodation body 18 is mounted on the mount section 16 by moving along the insertion direction Dp. The liquid accommodation body 18 mounted on the mount section 16 can supply liquid.

The removal direction De is a direction opposite to the insertion direction Dp. The liquid accommodation body 18 is pulled out from the mount section 16 by moving in the removal direction De. The insertion direction Dp and the removal direction De of the present embodiment are parallel to the Y-axis. The mounting space 22 extends along the insertion direction Dp.

The plurality of liquid accommodation bodies 18 may contain different types of liquids. The different types of liquids are, for example, inks of different colors. In present embodiment, four liquid accommodation bodies 18 contain cyan, magenta, yellow, and black inks, respectively.

The plurality of liquid accommodation bodies 18 may have the same configuration or may have different configurations. For example, the plurality of liquid accommodation bodies 18 may have different contained amounts of liquid. For example, the liquid accommodation body 18 that contains black ink may have a greater liquid capacity than the other liquid accommodation bodies 18. The liquid accommodation body 18 with a larger capacity may be wider than the liquid accommodation body 18 with a smaller capacity.

As illustrated in FIG. 2, the recording device 11 may include a first movement mechanism 24, a liquid ejection section 25 which is an example of a movement section, a first restriction member 26 which is an example of a restriction member, a second movement mechanism 27, a cap 28, a pocket 29, and a second restriction member 30.

### First Movement Mechanism

The first movement mechanism 24 moves the liquid ejection section 25. The first movement mechanism 24 may include a first drive section 32, a first pinion 33, and a first rack 34.

The first drive section 32 rotates the first pinion 33. The first pinion 33 meshes with the first rack 34. The first rack 34 moves with the rotation of the first pinion 33. The first rack 34 is movable in the first movement direction D1, which is an example of the movement direction, and the second movement direction D2, which is an example of the movement direction. The first movement direction D1 is a direction opposite to the second movement direction D2.

The liquid ejection section 25 moves together with the first rack 34. Therefore, the liquid ejection section 25 is movable in the first movement direction D1 and the second movement direction D2. The liquid ejection section 25 is movable between a capping position indicated by a solid line in FIG. 2 and a recording position indicated by a two-dot chain line in FIG. 2. The first movement direction D1 is a direction in which the liquid ejection section 25 approaches the mount section 16. The second movement direction D2 is a direction in which the liquid ejection section 25 is separated from the mount section 16. The liquid ejection section 25 located at the capping position reaches the recording position by moving in the second movement direction D2.

### First Drive Section

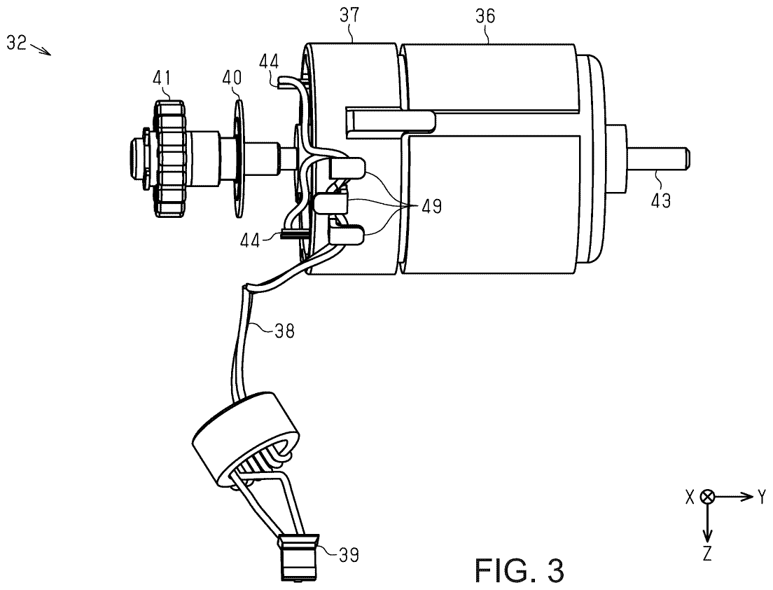

As shown in FIG. 3, the first drive section 32 may include a motor 36, a holder 37, two cables 38, a connector 39, a scale 40, and a knob 41.

The motor 36 has an output shaft 43 and two terminals 44. The output shaft 43 rotates as the motor 36 is driven. The output shaft 43 rotates the first pinion 33 directly or via a plurality of gears.

Two terminals 44 are provided on the side opposite to the output shaft 43. One end of cable 38 is coupled to each of the two terminals 44. The other ends of two cables 38 are coupled to the connector 39. The cable 38 couples between the motor 36 and the connector 39.

The holder 37 is mounted on the motor 36. The holder 37 is mounted on the side opposite to the output shaft 43. The holder 37 covers the end of the motor 36 on the side where the terminal 44 is provided. The holder 37 protects the end of the motor 36. The holder 37 reduces the risk of the cable 38 hitting the motor 36.

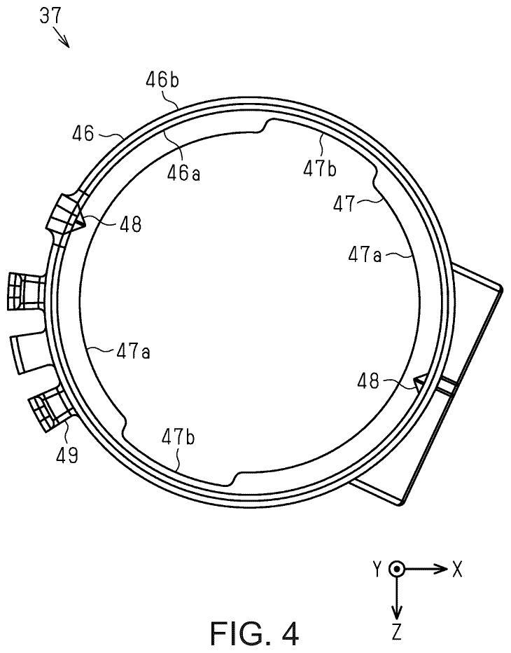

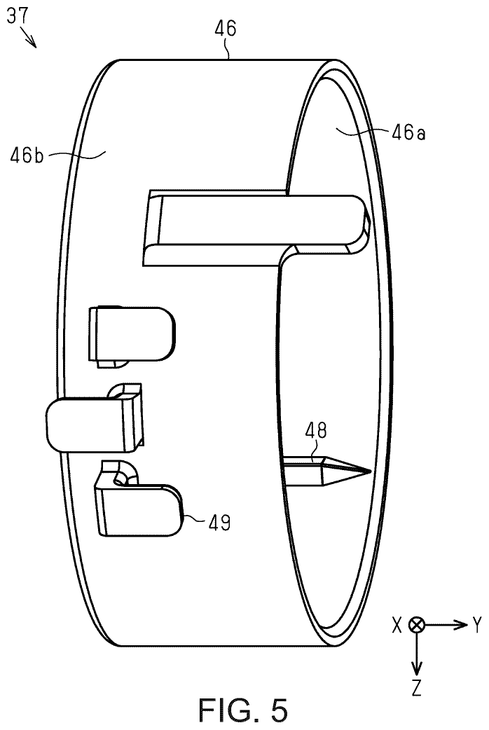

As shown in FIGS. 4 and 5, the holder 37 may include a side wall 46, an edge section 47, a protrusion 48, and a hook 49. The side wall 46, the edge section 47, the protrusion 48, and the hook 49 may be integrally formed. The holder 37 may be made of a resin such as polypropylene.

The side wall 46 may be cylindrical. The edge section 47 protrudes inside from the end of the side wall 46. The edge section 47 may include one or more wide sections 47a and one or more narrow sections 47b. The narrow section 47b may protrude from the side wall 46 by a smaller amount than the wide section 47a. By providing the narrow section 47b, the side wall 46 is more easily deformed.

The protrusion 48 is provided on an inner wall 46a of the side wall 46. The protrusion 48 may extend from the wide section 47a. The holder 37 may have a plurality of protrusions 48. The holder 37 of the present embodiment has two protrusions 48. The plurality of protrusions 48 may be provided at equal intervals in the circumferential direction. The plurality of protrusions 48 and a plurality of narrow sections 47b may be alternately provided at equal intervals in the circumferential direction.

The inside diameter of the plurality of protrusions 48 is smaller than the outer diameter of the motor 36. The inside diameter of the side wall 46 is larger than the outer diameter of the motor 36. When the holder 37 is attached to the motor 36, it is deformed into an elliptic cylindrical shape. By this, the holder 37 is less likely to drop out from the motor 36. The holder 37 mounted on the motor 36 may separate the motor 36 from the inner wall 46a. A gap between the motor 36 and the holder 37 prevents heat buildup.

The hook 49 is provided on an outer wall 46b of the side wall 46. The hook 49 holds the cable 38. By providing the hook 49, it is possible to reduce the risk that the cable 38 comes into contact with the scale 40.

As shown in FIG. 3, the scale 40 and the knob 41 are located on the opposite side of the output shaft 43. The scale 40 rotates as the motor 36 is driven. The rotation of the scale 40 is read by an encoder (not shown). The knob 41 can be operated by a user, for example. When the knob 41 is rotated, the output shaft 43 and the scale 40 are rotated.

### Liquid Ejection Section

As shown in FIG. 2, the liquid ejection section 25 may include a main body 51, a head 52, and a first engaged section 53. The head 52, the main body 51, and a first engaged section 53 may be arranged side by side in the first movement direction D1.

The first engaged section 53 may be a rod-shaped member extending in the depth direction Y. The first engaged section 53 may be provided at a position close to the mount section 16. In other words, in the first movement direction D1, the distance from the first engaged section 53 to the mount section 16 is shorter than the distance from the head 52 to the mount section 16.

The head 52 may have a nozzle face 55. The nozzle face 55 may be a plane perpendicular to the first movement direction D1. One or more nozzles 56 are opened in the nozzle face 55. The liquid ejection section 25 can perform recording on the medium 20 by ejecting liquid from the nozzle 56. The liquid ejection section 25 may be disposed in a posture in which the nozzle face 55 is inclined with respect to the horizontal direction. The liquid ejection section 25 of the present embodiment is a line head. The liquid ejection section 25 may be provided with the insertion direction Dp in which the mounting space 22 extends as a longitudinal direction.

### Second Restriction Member

The second movement mechanism 27 moves the cap 28. The second movement mechanism 27 may include a second drive section 58, a second pinion 59, and a second rack 60. The configuration of the second drive section 58 may be the same as the configuration of the first drive section 32.

The second drive section 58 rotates the second pinion 59. The second pinion 59 meshes with the second rack 60. The second rack 60 moves in the third movement direction D3 and the fourth movement direction D4 with the rotation of the second pinion 59. The third movement direction D3 is opposite direction to the fourth movement direction D4.

The cap 28 moves together with the second rack 60. Therefore, the cap 28 is movable in the third movement direction D3 and the fourth movement direction D4. The cap 28 located at the retreat position indicated by the two-dot chain line in FIG. 2 moves in the third movement direction D3 to reach the capping position indicated by the solid line in FIG. 2. The cap 28 positioned at the capping position can cap the liquid ejection section 25 by covering the nozzle 56.

The second restriction member 30 can be attached to the pocket 29. The second restriction member 30 is detachably attached to the pocket 29.

The second restriction member 30 may include a mounting hole 62 and one or more restricting teeth 63. A mounting rod 64 can be inserted into the mounting hole 62. The second restriction member 30 may be attached to the pocket 29 in a state of being held at the tip end of the mounting rod 64. The mounting rod 64 may be removable from the mounting hole 62 in a state where the second restriction member 30 is attached to the pocket 29. The second restriction member 30 housed in the pocket 29 may be removed from the pocket 29 by operating the mounting rod 64 inserted into the mounting hole 62. The mounting rod 64 may be a dedicated member for attaching and detaching the second restriction member 30, or other members may be diverted. For example, the mounting rod 64 may be diverted from a member used for cleaning a sensor or the like.

The plurality of restricting teeth 63 are arranged at equal intervals in the third movement direction D3. In a state where the second restriction member 30 is attached to the pocket 29, the restricting tooth 63 meshes with the second rack 60. The second restriction member 30 restricts the movement of the second rack 60 and the cap 28 by meshing with the second rack 60. The second rack 60 and the cap 28 are movable in the third movement direction D3 and the fourth movement direction D4 when the second restriction member 30 is removed from the pocket 29.

### First Restriction Member

As shown in FIG. 2, the first restriction member 26 is attachable to and detachable from the liquid ejection section 25. The first restriction member 26 is attached to the liquid ejection section 25. The first restriction member 26 can restrict the movement of the liquid ejection section 25 in the first movement direction D1 and the second movement direction D2. The state in FIG. 2, in which the first restriction member 26 restricts the movement of the liquid ejection section 25, is also referred to as a restricted state. The first restriction member 26 may restrict the central section of the liquid ejection section 25 in the longitudinal direction.

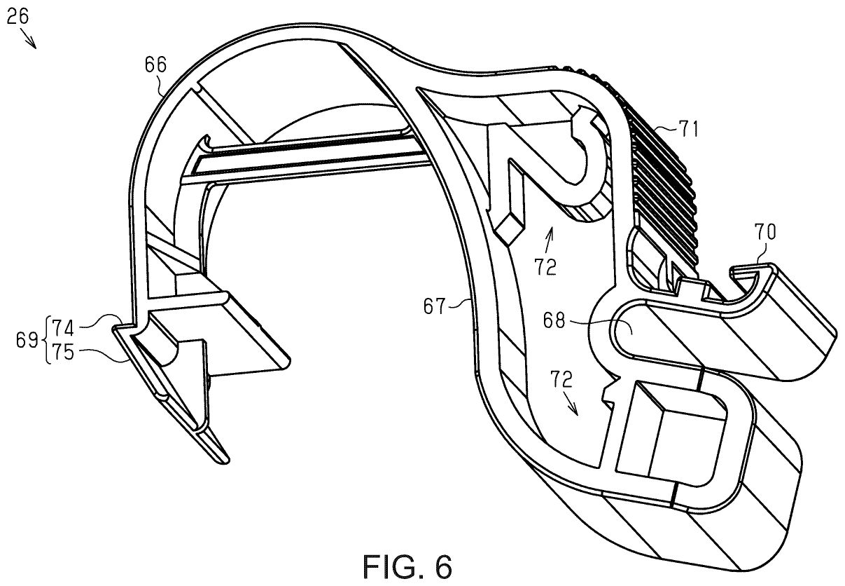

As shown in FIG. 6, the first restriction member 26 may include a thin section 66 and a thick section 67. The first restriction member 26 may include a first engagement section 68, a second engagement section 69, and a third engagement section 70. The first restriction member 26 may include an anti-slip section 71 and a guide section 72.

The thin section 66 is curved. The thin section 66 is more easily deformed than the thick section 67.

The second engagement section 69 may be provided at the tip end of the thin section 66. The second engagement section 69 may include an engagement claw 74 and an inclined surface 75. The engagement claw 74 and the inclined surface 75 obliquely cross each other.

The first engagement section 68 and the third engagement section 70 may be provided at the tip end of the thick section 67. The anti-slip section 71 and the guide section 72 may be provided on the thick section 67. The guide section 72 guides the procedure when the first restriction member 26 is mounted on the liquid ejection section 25. The guide section 72 may be a plurality of numbers indicating the mounting procedure.

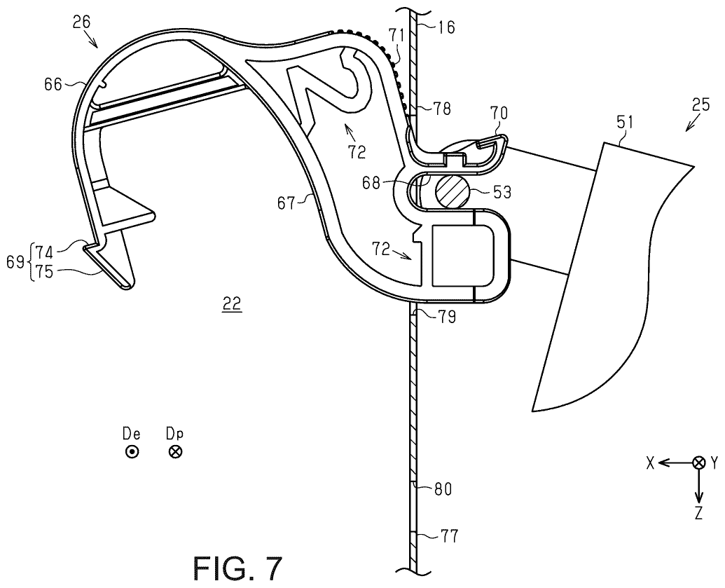

As shown in FIG. 7, the mount section 16 may include a second engaged section 77, a third engaged section 78, a first insertion hole 79, and a second insertion hole 80. The first insertion hole 79 and the second insertion hole 80 are open to the mounting space 22. The second engaged section 77 is positioned below the second insertion hole 80. The third engaged section 78 is positioned above the first insertion hole 79.

When the first restriction member 26 is attached, the operator inserts the first restriction member 26 in the attachment/detachment posture shown in FIG. 7 into the first insertion hole 79. The tip end of the thick section 67 of the first restriction member 26 is inserted into the first insertion hole 79. In the first restriction member 26, the first engagement section 68 engages with the first engaged section 53.

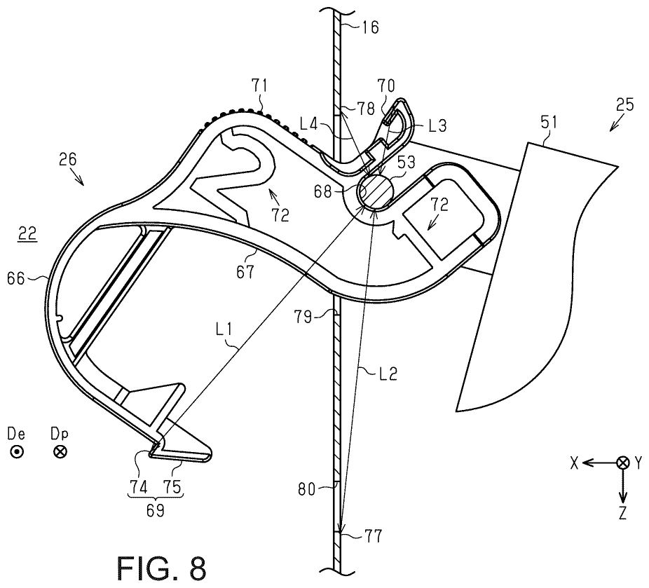

As shown in FIG. 8, the operator rotates the first restriction member 26 about the first engaged section 53 in a state where the first engagement section 68 is engaged with the first engaged section 53. The operator rotates the first restriction member 26 in counterclockwise direction in FIG. 8. The rotation direction of the first restriction member 26 is the direction such that the second engagement section 69 approaches the second engaged section 77.

The first length L1 that is from the first engagement section 68 to the second engagement section 69 may be equal to the second length L2 that is from the first engaged section 53 to the second engaged section 77. A third length L3 that is from the first engagement section 68 to the third engagement section 70 may be equal to a fourth length L4 that is from the first engaged section 53 to the third engaged section 78. Therefore, when the first restriction member 26 rotates about the first engaged section 53, the second engagement section 69 engages with the second engaged section 77, and the third engagement section 70 engages with the third engaged section 78.

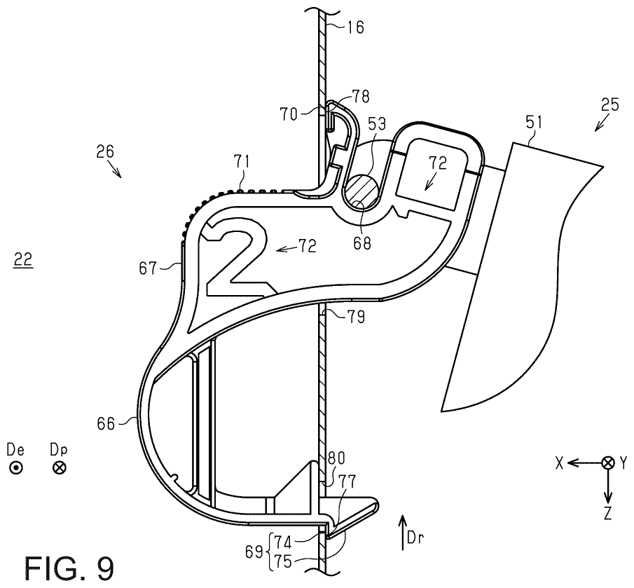

As shown in FIG. 9, in the first restriction member 26, the second engagement section 69 is inserted into the second insertion hole 80, and the engagement claw 74 is engaged with the second engaged section 77. Specifically, in the second engagement section 69, the inclined surface 75 abuts against the second insertion hole 80, and the thin section 66 is deformed. When the inclined surface 75 passes through the second insertion hole 80, the engagement claw 74 engages with the second engaged section 77. The posture of the first restriction member 26 in which the second engagement section 69 engages with the second engaged section 77 is also referred to as a mounting posture. The mounting posture is the posture of the first restriction member 26 in the restricted state. In the first restriction member 26 of the mounting posture, the third engagement section 70 engages with the third engaged section 78.

When the operator removes the first restriction member 26, the operator first releases the engagement of the second engagement section 69. The operator releases the engagement by pushing the tip end side of the thin section 66 in the release direction Dr, which is an example of a second direction. The release direction Dr is a direction in which the engagement claw 74 is disengaged from the second engaged section 77. The operator moves the second engagement section 69 in the release direction Dr by pushing the tip end of the thin section 66 toward the thick section 67. The release direction Dr is a different direction from the insertion direction Dp. When the second engagement section 69 is disengaged, the first restriction member 26 becomes rotatable.

The operator rotates the first restriction member 26 so as to lift the thin section 66. The operator rotates the first restriction member 26 about the first engaged section 53 in the clockwise direction in FIG. 8. After the operator rotates the first restriction member 26 to the attachment/detachment posture shown in 7, the operator removes the first restriction member 26 from the first insertion hole 79.

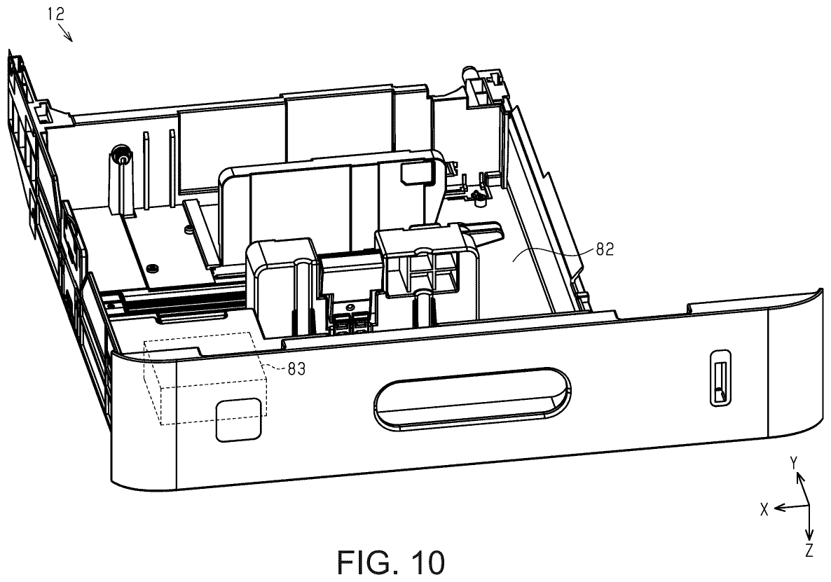

As shown in FIG. 10, the cassette 12 has a placement section 82. The placement section 82 is provided to place the medium 20. The cassette 12 may include a storage section 83. The storage section 83 can store the first restriction member 26 detached from the liquid ejection section 25. The storage section 83 may be provided at a position different from the placement section 82.

As shown in 11, the storage section 83 may be accessible from the back side of the cassette 12. The storage section 83 may include a recess section 85 and a holding claw 86. The recess section 85 may be provided on a bottom surface 87 of the cassette 12. The holding claw 86 is engageable with the first restriction member 26. The holding claw 86 is elastically deformable. The operator can remove the first restriction member 26 from the storage section 83 by deforming the holding claw 86.

### Action of First Embodiment

The operation of the present embodiment will be described.

As shown in FIG. 2, when the recording device 11 is transported, the second restriction member 30 may be attached to the pocket 29. The movement of the cap 28 may be restricted in a state where it is located at the capping position.

In case of the recording device 11 is transported, the first restriction member 26 engages with the liquid ejection section 25 to be in a restricted state. The first restriction member 26 in the restricted state may restrict the movement of the liquid ejection section 25 capped by the cap 28.

The first restriction member 26 is positioned in the mounting space 22 in the restricted state. Specifically, in the restricted state, the thin section 66 is positioned in the mounting space 22. In the restricted state, at least a part of the guide section 72 may be positioned in the mounting space 22. A portion of the first restriction member 26 located in the mounting space 22 is visible through the opening section 17.

When the liquid accommodation body 18 is inserted into the mount section 16 in the restricted state, the liquid accommodation body 18 may come into contact with the first restriction member 26. For example, the first restriction member 26 may be positioned in the movement path of the liquid accommodation body 18 having a narrow width. In a case where the plurality of liquid accommodation bodies 18 can be mounted on the mount section 16, the first restriction member 26 may restrict the movement of at least one liquid accommodation body 18 in the insertion direction Dp.

At least a part of the liquid accommodation body 18 that has come into contact with the first restriction member 26 may be located outside the mounting space 22 through the opening section 17. In a case where the liquid accommodation body 18 is inserted into the opening section 17 in the restricted state, the cover 15 cannot be brought into the closed state.

### Effect of First Embodiment

Effect of the present embodiment will be described.

1-1: The first restriction member 26, which restricts the movement of the liquid ejection section 25, is positioned in the mounting space 22. In other words, the first restriction member 26 does not protrude outward. When the recording device 11 is transported, since it is possible to reduce the risk that the first restriction member 26 is caught by something, it is possible to reduce the risk that the first restriction member 26 is erroneously detached. When the recording device 11 is used, the liquid accommodation body 18 cannot be mounted in the mounting space 22 unless the first restriction member 26 is removed. Therefore, it is possible to reduce the risk of forgetting to remove the first restriction member 26. Therefore, it is possible to reduce the risk that the first restriction member 26 is detached during transportation and the risk that the first restriction member 26 is forgotten to be detached during use.

1-2: When the first restriction member 26 is in the restricted state, a portion of the liquid accommodation body 18 protrudes from the opening section 17. Therefore, the operator can easily recognize that the first restriction member 26 is not removed.

1-3: The cover 15 covers the opening section 17. The cover 15 cannot be closed in a state where a part of the liquid accommodation body 18 protrudes from the opening section 17. Therefore, the operator can easily recognize that the first restriction member 26 is not removed.

1-4: The opening section 17 is on the front of the recording device 11. Therefore, since the attachment and detachment of the first restriction member 26 and the mounting of the liquid accommodation body 18 can be performed from the front side of the recording device 11, it is possible to improve workability.

1-5: The first length L1 that is from the first engagement section 68 to the second engagement section 69 is the same as the second length L2 that is from the first engaged section 53 to the second engaged section 77. Therefore, the operator can engage the second engagement section 69 with the second engaged section 77 by rotating the first restriction member 26 having the first engagement section 68 engaged with the first engaged section 53 about the first engaged section 53. Therefore, since the first restriction member 26 can be easily mounted, workability can be improved.

1-6: The release direction Dr, which is an example of the second direction in which the engagement between the second engagement section 69 and the second engaged section 77 is released, is a direction different from the insertion direction Dp in which the liquid accommodation body 18 is mounted. Therefore, even when the liquid accommodation body 18 moving in the insertion direction Dp comes into contact with the first restriction member 26, it is possible to reduce the risk that the restricted state of the first restriction member 26 is released.

1-7: The first restriction member 26 can be housed in the storage section 83. Therefore, when the first restriction member 26 is not used, it can be stored in the storage section 83, and thus it is possible to reduce the risk that the first restriction member 26 is lost. The storage section 83 is provided in the cassette 12 that stores the medium 20. Therefore, since the operator can easily access the storage section 83, workability can be improved.

1-8: The storage section 83 is provided at a position different from the placement section 82. Therefore, it is possible to reduce the risk that the first restriction member 26 accommodated in the storage section 83 comes into contact with the medium 20 placed on the placement section 82.

1-9: The storage section 83 is provided on the bottom surface 87 of the cassette 12. Therefore, since the first restriction member 26 accommodated in the storage section 83 is less likely to be seen by the user, it is possible to reduce the risk that the user may erroneously use the first restriction member 26. The first restriction member 26 engages with the holding claw 86. Therefore, for example, even in a case where an impact is applied when the cassette 12 is inserted and pulled out, it is possible to reduce a risk that the first restriction member 26 drop out from the storage section 83.

1-10: In order for the liquid ejection section 25 to perform recording by ejecting liquid, it is necessary to mount the liquid accommodation body 18. Since the liquid accommodation body 18 cannot be mounted unless the first restriction member 26 is removed, it is possible to reduce the risk that the liquid accommodation body 18 will be used with the first restriction member 26 mounted.

1-11: The first restriction member 26 restricts the movement of the liquid ejection section 25 in a state where the liquid ejection section 25 is capped. Therefore, it is possible to reduce the risk that the nozzle 56 dries out even during transportation.

1-12: The liquid ejection section 25 is a line head. The first restriction member 26 restricts the central section of the liquid ejection section 25 in the longitudinal direction. Therefore, for example, compared to a case where the end of the liquid ejection section 25 is restricted, it is possible to effectively suppress the movement of the liquid ejection section 25.

### Second Embodiment

Next, a second embodiment of the recording device will be described with reference to the drawings. The second embodiment is different from the first embodiment in the location where the first engaged section is provided. In other respects, the second embodiment is substantially the same as the first embodiment, so the same components are denoted by the same reference numerals, and redundant description thereof will be omitted.

### Frame

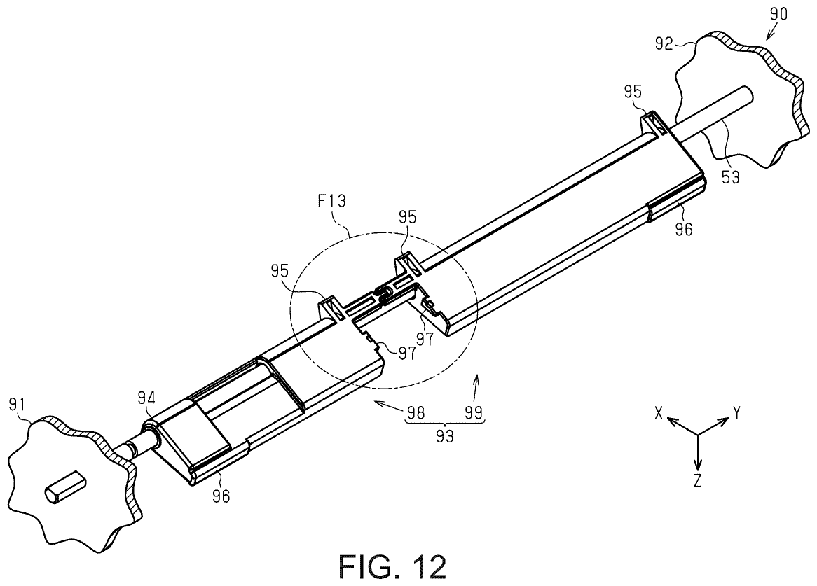

As shown in FIG. 12, the recording device 11 is provided with a frame 90 that is immovable. The frame 90 may include a first side plate 91, a second side plate 92, and a first engaged section 53. In other words, the first engaged section 53 is provided at the frame 90.

The first side plate 91 is provided at the front side in the depth direction Y. The second side plate 92 is provided at the rear side in the depth direction Y. The first side plate 91 and the second side plate 92 may be provided in parallel to each other. The first side plate 91 and the second side plate 92 may support the liquid ejection section 25 in a movable manner.

### First Engaged Section

In present embodiment, the first engaged section 53 is immovable. The first engaged section 53 may be a rod-shaped member extending in the depth direction Y. The front side end of the first engaged section 53 in the depth direction Y is supported by the first side plate 91. The back side end of the first engaged section 53 in the depth direction Y is supported by the second side plate 92.

### Displacement Member

As shown in 12, the recording device 11 includes a displacement member 93. The displacement member 93 may be attached to the first engaged section 53. The displacement member 93 extends in the depth direction Y, which is a direction along the longitudinal direction of the liquid ejection section 25. The first engaged section 53 penetrates the displacement member 93 in the depth direction Y. The displacement member 93 is rotatable about the first engaged section 53.

The recording device 11 may include one or more fasteners 94. The fastener 94 positions the displacement member 93 in the depth direction Y with respect to the first engaged section 53. The recording device 11 of the present embodiment includes two fasteners 94. Two fasteners 94 define the positions of both ends of the displacement member 93 in the depth direction Y.

The displacement member 93 may include a limitation section 95, a contact section 96, and a fourth engaged section 97, which is an example of the engaged section. The displacement member 93 may include a plurality of limitation sections 95, a plurality of contact sections 96, and a plurality of fourth engaged sections 97. The limitation section 95 may be positioned opposite to the contact section 96 with respect to the first engaged section 53. Two contact sections 96 may be located at both ends of the displacement member 93 in the depth direction Y. The contact sections 96 may be positioned behind of the fourth engaged section 97 and in front of the fourth engaged section 97 in the depth direction Y.

The displacement member 93 may include a first part 98 and a second part 99. By configuring the displacement member 93 with two components, warpage can be suppressed as compared with a case where the displacement member 93 is configured with one component.

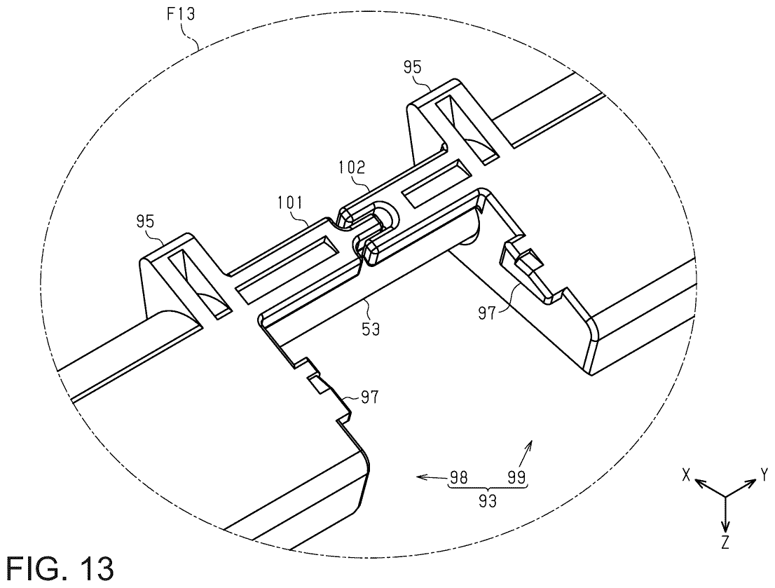

As shown in FIG. 13, the displacement member 93 of the present embodiment includes two fourth engaged sections 97. Two fourth engaged sections 97 are provided with a gap therebetween in the depth direction Y. The fourth engaged section 97 may be provided in each of the first part 98 and the second part 99. The fourth engaged section 97 of the first part 98 protrudes toward the second part 99 in the depth direction Y. The fourth engaged section 97 of the second part 99 protrudes toward the first part 98 in a direction opposite to the depth direction Y. Two fourth engaged sections 97 face each other.

The first part 98 may include a first assembly section 101. The first assembly section 101 protrudes in the depth direction Y toward the second part 99. The amount by which the first assembly section 101 protrudes is larger than the amount by which the fourth engaged section 97 protrudes.

The second part 99 may include a second assembly section 102. The second assembly section 102 protrudes toward the first part 98 on the opposite direction in the depth direction Y. The amount by which the second assembly section 102 protrudes is larger than the amount by which the fourth engaged section 97 protrudes. The tip end of the second assembly section 102 is recessed in the depth direction Y.

The tip end of the first assembly section 101 is narrower than the tip end recess of the second assembly section 102. The first part 98 and the second part 99 are assembled by fitting the tip end of the first assembly section 101 into the tip end of the second assembly section 102. When the first part 98 and the second part 99 are assembled, the rotation angles about the first engaged section 53 are aligned. By making the shapes of the tip end of the first assembly section 101 and the second assembly section 102 different from each other, for example, it is possible to reduce the risk that the first assembly sections 101 are assembled to each other, or the second assembly sections 102 are assembled to each other.

When the materials of the first engaged section 53 and the displacement member 93 are different, the first engaged section 53 and the displacement member 93 may have different coefficients of thermal expansion. For example, when the first engaged section 53 is made of metal and the displacement member 93 is made of resin having a larger thermal expansion coefficient than the first engaged section 53, the displacement member 93 is more likely to expand than the first engaged section 53. Both ends of the displacement member 93 in the depth direction Y are positioned by the fastener 94. Therefore, the first part 98 and the second part 99 expand so as to approach each other. At this time, if a backlash is provided between the first assembly section 101 and the second assembly section 102, the expansion of the displacement member 93 can be allowed.

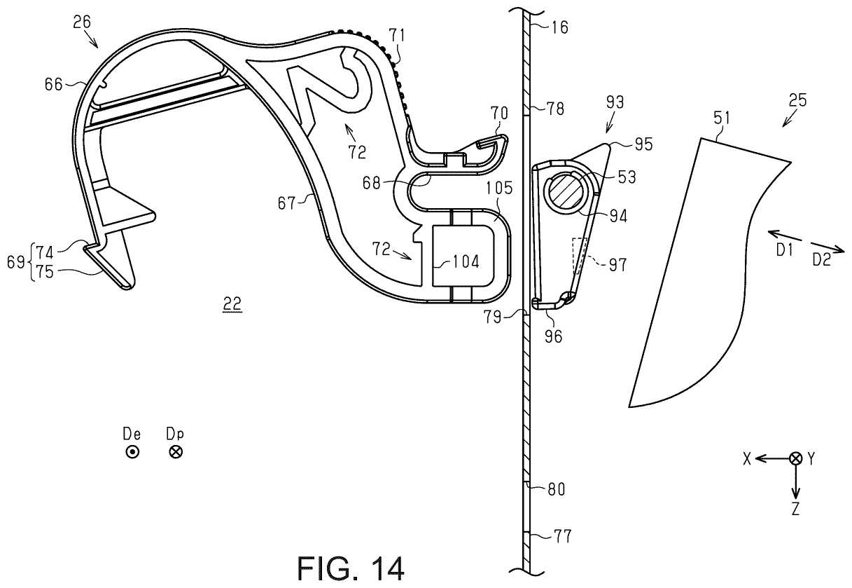

As shown in FIG. 14, the centroid of the displacement member 93 is closer to the contact section 96 than the first engaged section 53. The state shown in FIG. 14 where the displacement member 93 does not receive an external force is also referred to as a released state. In the released state, the displacement member 93 is positioned such that the contact section 96 is below the first engaged section 53. In the released state, the displacement member 93 has the limitation section 95 positioned above the first engaged section 53. In the released state, the displacement member 93 and the liquid ejection section 25 may have parallel surfaces facing each other. When the opposing surfaces of the displacement member 93 and the liquid ejection section 25 are parallel to each other, the movement range of the liquid ejection section 25 can be increased.

### First Restriction Member

As shown in FIGS. 14 to 17, the first restriction member 26 is attachable to and detachable from the frame 90. Specifically, the first restriction member 26 is attachable to and detachable from the first engaged section 53. The first restriction member 26 can restrict the movement of the liquid ejection section 25 in the first movement direction D1 by being mounted on the frame 90.

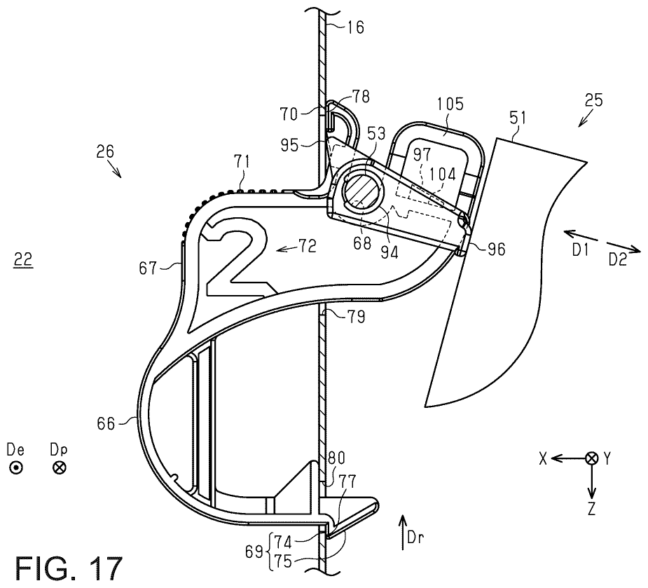

The first restriction member 26 is attached to the first engaged section 53. The first restriction member 26 can restrict the movement of the liquid ejection section 25 in the first movement direction D1 in the restricted state illustrated in FIG. 17 in which the first restriction member 26 is attached to the first engaged section 53.

As shown in FIG. 14, the first restriction member 26 includes a fourth engagement section 104, which is an example of an engagement section, and a recessed section 105. The first restriction member 26 of the present embodiment includes two fourth engagement sections 104 and two recessed sections 105. In the first restriction member 26 in the attachment/detachment posture shown in FIG. 14, the fourth engagement sections 104 and the recessed sections 105 may be provided at both sides in the depth direction Y. The fourth engagement section 104 may be provided at the guide section 72. The recessed section 105 is provided closer to the tip end than the fourth engagement section 104. In the first restriction member 26, the size that is from one recessed section 105 to the other recessed section 105 in the depth direction Y is smaller than the size that is from the end of one fourth engagement section 104 to the end of the other fourth engagement section 104 in the depth direction Y.

The mounting of the first restriction member 26 may be performed in a state in which the liquid ejection section 25 is positioned at a position close to the mount section 16, for example, a capping position illustrated in FIG. 14. The cap 28 may push the liquid ejection section 25 located at the capping position in the first movement direction D1 by a spring (not shown).

When attaching the first restriction member 26, the operator inserts the first restriction member 26 in the attachment/detachment posture shown in FIG. 14 into the first insertion hole 79. The tip end of the thick section 67 of the first restriction member 26 is inserted into the first insertion hole 79. In the first restriction member 26, the first engagement section 68 engages with the first engaged section 53.

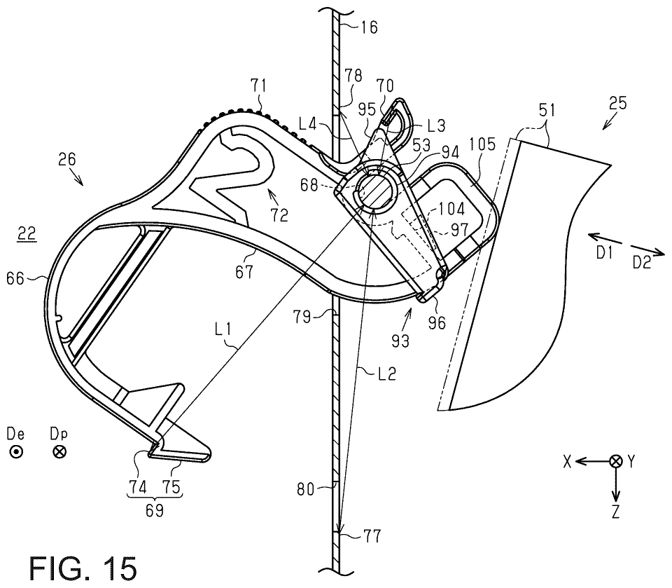

As shown in FIG. 15, the operator rotates the first restriction member 26 about the first engaged section 53 in a state where the first engagement section 68 is engaged with the first engaged section 53. The operator rotates the first restriction member 26 in the counterclockwise direction in FIG. 15. The rotation direction of the first restriction member 26 is the direction such that the second engagement section 69 approaches the second engaged section 77.

When the rotated first restriction member 26 comes into contact with the liquid ejection section 25, the first restriction member 26 may push down the liquid ejection section 25. The cap 28 may allow displacement of the liquid ejection section 25 by contraction of a spring (not illustrated).

The first length L1 that is from the first engagement section 68 to the second engagement section 69 may be equal to the second length L2 that is from the first engaged section 53 to the second engaged section 77. A third length L3 that is from the first engagement section 68 to the third engagement section 70 may be equal to a fourth length L4 that is from the first engaged section 53 to the third engaged section 78. Therefore, when the first restriction member 26 rotates about the first engaged section 53, the second engagement section 69 engages with the second engaged section 77, and the third engagement section 70 engages with the third engaged section 78.

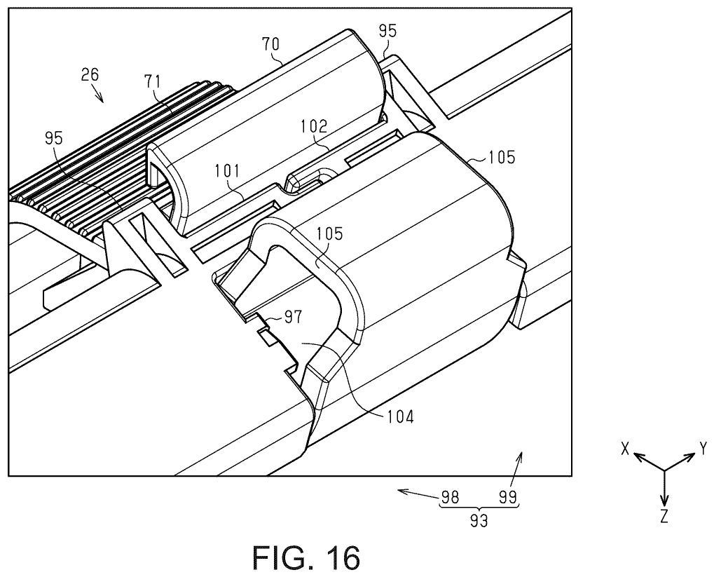

As shown in FIGS. 15 and 16, the rotating first restriction member 26 has the fourth engagement section 104 engaged with the fourth engaged section 97. As the first restriction member 26 rotates, the fourth engagement section 104 pushes up the fourth engaged section 97. When the fourth engagement section 104 engages with the fourth engaged section 97, the first restriction member 26 displaces the displacement member 93 to the restricting position shown in FIG. 17. In other words, the displacement member 93 is displaced to the restricting position when the first restriction member 26 is attached to the frame 90.

The first engagement section 68 that engages with the first engaged section 53 may engage with the first assembly section 101 and the second assembly section 102. By this, since the displacement member 93 and the first restriction member 26 can be aligned with each other, the fourth engagement section 104 and the fourth engaged section 97 can be easily engaged with each other.

As shown in FIG. 17, the contact section 96 of the displacement member 93 positioned at the restricting position may come into contact with the liquid ejection section 25. The displacement member 93 positioned at the restricting position restricts the movement of the liquid ejection section 25 in the first movement direction D1 together with the first restriction member 26. The limitation section 95 of the displacement member 93 located at the restricting position may be in contact with the mount section 16. When the limitation section 95 comes into contact with the mount section 16, further rotation of the displacement member 93 can be suppressed.

The first restriction member 26 assumes the mounting posture by the second engagement section 69 inserted into the second insertion hole 80. In the first restriction member 26 in the mounting posture, the second engagement section 69 engages with the second engaged section 77, and the third engagement section 70 engages with the third engaged section 78. The first restriction member 26 in the mounting posture holds the displacement member 93 at the restricting position.

When the operator removes the first restriction member 26, the operator first releases the engagement of the second engagement section 69. The operator rotates the first restriction member 26 so as to lift the thin section 66. The operator rotates the first restriction member 26 about the first engaged section 53 in the clockwise direction in FIG. 15. When the first restriction member 26 is rotated, the displacement member 93 rotates in accordance with the rotation of the first restriction member 26.

As shown in FIG. 14, after rotating the first restriction member 26 to the attachment/detachment posture, the operator removes the first restriction member 26 from the first insertion hole 79. When the first restriction member 26 is separated from the displacement member 93, the displacement member 93 is in the released state.

### Action of Second Embodiment

The operation of the present embodiment will be described.

As shown in FIG. 17, when the recording device 11 is transported, the first restriction member 26 is engaged with the frame 90 to be in the restricted state. The first restriction member 26 in the restricted state restricts the movement of the liquid ejection section 25 by positioning the displacement member 93 at the restricting position. The first restriction member 26 is positioned in the mounting space 22 in the restricted state.

### Effects of Second Embodiment

Effect of the present embodiment will be described.

2-1: The first restriction member 26 displaces the displacement member 93 to the restricting position by engaging the first engagement section 68 with the first engaged section 53. Therefore, the movement of the movement section in the movement direction can be regulated with a simple configuration.

2-2: For example, in a case where the length of the liquid ejection section 25 is long, there is a risk that the liquid ejection section 25 may be inclined even when a part of the movement is regulated. In this regard, according to this configuration, the displacement member 93 extends in the depth direction Y along the longitudinal direction of the liquid ejection section 25. Therefore, the displacement member 93 can restrict the movement of the liquid ejection section 25 in the longitudinal direction. Therefore, it is possible to stably restrict the movement of the liquid ejection section 25.

### Modified Example

The present embodiment can be implemented with the following modifications. The present embodiment and the following modified examples can be implemented in combination with each other within a range that has no technical contradiction.
The first restriction member 26 may restrict the tip end of the liquid ejection section 25 in the longitudinal direction.
The insertion direction Dp in which the mounting space 22 extends and the longitudinal direction of the liquid ejection section 25 may be different direction.
The liquid ejection section 25 may be a serial head. For example, the liquid ejection section 25 may be movable in the depth direction Y, which is an example of the movement direction.
The first restriction member 26 in the restricted state may restrict the movement of the liquid ejection section 25 which is not capped.
The mounting rod 64 may be fixed to the second restriction member 30. The second restriction member 30 may include the mounting rod 64. When the second restriction member 30 is attached to the pocket 29, the mounting rod 64 may be positioned in the mounting space 22, for example. In this case, the second restriction member 30 functions as an example of a restriction member, and the cap 28 functions as an example of a movement section.
The recording device 11 may include a wiper that functions as an example of a movement section. The wiper may wipe the nozzle face 55 by coming into contact with the nozzle face 55 while moving in the depth direction Y, which is an example of the movement direction.
The recording device 11 may include a plurality of mount sections 16.
A waste liquid tank, which is an example of a attachment member, may be mounted on the mount section 16. The waste liquid tank may store the liquid discharged during maintenance of the liquid ejection section 25 as waste liquid.
A toner cartridge, which is an example of an attachment member, may be attachable to the mount section 16. The toner cartridge may contain a toner used for recording.
A toner box, which is an example of an attachment member, may be attachable to the mount section 16. The toner box may contain the collected toner.
A plurality of different types of attachment members may be mounted on one mount section 16. For example, the liquid accommodation body 18 and a waste liquid container may be attachable to the mount section 16.
The storage section 83 may be provided at a position different from the cassette 12.
The storage section 83 may be capable of storing the second restriction member 30.

The storage section 83 may be provided on the upper surface of the cassette 12. The storage section 83 may be provided on the placement section 82.
The shape of recess section 85 may be matched with the shape of the first restriction member 26. The first restriction member 26 may be accommodated so as to be fitted in the recess section 85. In this case, the storage section 83 may not include the holding claw 86.
The mount section 16 may not have the second insertion hole 80. The first restriction member 26 in the restricted state may maintain the mounting posture by its own weight.
The first restriction member 26 may be configured without at least one of the second engagement section 69 and the third engagement section 70.
In the second embodiment, the mounting of the first restriction member 26 may be performed in a state where the liquid ejection section 25 is positioned at, for example, a recording position indicated by a two-dot chain line in FIG. 2 which is separated from the mount section 16. After the first restriction member 26 is mounted on the liquid ejection section 25, the liquid ejection section 25 may be moved to, for example, a capping position close to the mount section 16. The cap 28 may push the liquid ejection section 25 against the displacement member 93. The displacement member 93 and the cap 28 may restrict the movement of the liquid ejection section 25 in the first movement direction D1 and the second movement direction D2 by sandwiching the liquid ejection section 25 from both sides.
In the second embodiment, the recording device 11 may be configured without the displacement member 93. The first restriction member 26 mounted on the frame 90 restricts the movement of the liquid ejection section 25 in the first movement direction D1.
In the second embodiment, the first restriction member 26 mounted on the frame 90 may not be in contact with the liquid ejection section 25. The first restriction member 26 mounted on the frame 90 displaces the displacement member 93 to the restricting position. The movement of the liquid ejection section 25 may be restricted by the displacement member 93 located at the restricting position.
In the second embodiment, the first restriction member 26 may be engaged with the frame 90 at the central section in the depth direction Y or may be engaged with the frame 90 at a position different from the central section. For example, the first restriction member 26 may engage with the frame in the vicinity of the opening section 17 and push up the end of the displacement member 93 on the front side in the depth direction Y to displace the displacement member to the restricting position.
The recording device 11 may further include a mechanism that moves the displacement member 93. For example, the displacement member 93 may be fixed to the first engaged section 53. For example, when it is detected that the first restriction member 26 is mounted, the recording device 11 may displace the displacement member 93 to the restricting position by rotating the first engaged section 53.
The recording device 11 is not limited to a inkjet printer, and may be a laser printer, a thermal printer, an dot-impact printer, a digital printing machine, or the like.
The recording device 11 may be a liquid ejection device that performs recording by ejecting or discharging a liquid other than ink. The state of the liquid which is discharged from the liquid ejection device ejecting liquid as a minute amount of droplet includes a granular shape, a tear shape, and a shape with a thread-like tail. Here, the liquid may be material that can be ejected from the liquid ejection device. For example, the liquid may be in a liquid state where a substance is in a liquid phase and the liquid includes a fluid such as a body with high or low viscosity, a sol, gel water, other inorganic solvents, an organic solvent, a solution liquid, a liquid resin, a liquid metal, and a molten liquid-phase metal. The liquid includes not only a liquid as one state of a substance but also a in which particles of a functional material made of a solid material such as a pigment or metal particles are dissolved, dispersed, or mixed in a solvent. Typical examples of the liquid include ink and liquid crystal as described in the above. Here, an ink includes various liquid compositions such as general water-based ink, oil-based ink, gel ink, and hot-melt ink. As a specific example of the liquid ejection device, for example, there is a device that ejects a liquid containing a material such as an electrode material or a color material used for manufacturing a liquid crystal display, an electroluminescence display, a surface emitting display, a color filter, or the like in a dispersed or dissolved form. The liquid ejection device may be a device that ejects a bioorganic substance used for manufacturing a biochip, a device that is used as a precision pipette and ejects liquid serving as a sample, a textile printing apparatus, a micro dispenser, or the like. The liquid ejection device may be a device that ejects lubricating oil to a precision machine such as a watch or a camera in a pinpoint manner, or a device that ejects a transparent resin liquid such as an ultraviolet curable resin onto a substrate in order to form a micro hemispherical lens, an optical lens, or the like used in an optical communication element or the like. The liquid ejection device may be a device that ejects an etchant such as an acid liquid or an alkali liquid for etching a substrate or the like.

### Definition

In this specification, the phrase “at least one” means “one or more” of the desired alternatives. As an example, the phrase “at least one” as used herein means “only one option” or “both options” if the number of options is two. As another example, as used herein, the phrase “at least one” means “only one option”, “a combination of two options”, or “a combination of three or more options” if the number of options is three or more.

### Notes

Hereinafter, technical ideas grasped from the above-described embodiment and modified example, and their operational effects will be described.

(A) A recording device includes a movement section configured to move in a movement direction; a mount section including a mounting space in which an attachment member that was inserted from an opening section is attachable; a restriction member that is attachable to and detachable from the movement section and is configured to restrict movement of the movement section in the movement direction by being attached to the movement section, wherein the restriction member is positioned in the mounting space when the restriction member is in a restricted state in which the restriction member restricts movement of the movement section.

According to this configuration, the restriction member that restricts the movement of the movement section is positioned in the mounting space. In other words, the restriction member does not protrude to the outside. Since it is possible to reduce the risk that the restriction member is caught by something when the recording device is transported, it is possible to reduce the risk that the restriction member is erroneously detached. When the recording device is used, the attachment member cannot be mounted in the mounting space unless the restriction member is removed. Therefore, it is possible to reduce the risk of forgetting to remove the restriction member. Therefore, it is possible to reduce the risk that the restriction member is drop out during transportation and the risk that the restriction member is forgotten to be detached during use.

(B) A recording device includes a movement section configured to move in a movement direction; a mount section including a mounting space in which an attachment member that was inserted from an opening section is attachable; a fixed frame; a restriction member that is attachable to and detachable from the frame and that is configured to restrict movement of the movement section in the movement direction by being attached to the frame; and a displacement member configured to, by the restriction member being attached to the frame, be displaced to a restricting position at which the displacement member, together with the restriction member, restricts movement of the movement section in movement direction, wherein the restriction member is positioned in the mounting space when the restriction member is in a restricted state in which the restriction member restricts movement of the movement section. According to this configuration, the same effect as the recording device above described can be achieved.

(C) In the recording device according to (A) or (B), when the attachment member is inserted into the mount section in the restricted state, at least a part of the attachment member may be located outside of the mounting space via opening section.

According to this configuration, when the restriction member is in the restricted state, a part of the attachment member protrudes via the opening section. Therefore, the operator can easily recognize that the restriction member is not removed.

(D) The recording device described in (A) to (C) may include a cover configured to be displaced between a closed state in which the cover covers the opening section and an open state in which the cover does not cover the opening section.

According to this configuration, the cover covers the opening section. The cover cannot close if a part of the attachment member protrudes from the opening section. Therefore, the operator can easily recognize that the restriction member is not removed.

(E) In the recording device described in (A) to (D), the opening section may open to the front surface of the device.

According to this configuration, the opening section is open to the front surface of the device. Therefore, since the attachment and detachment of the restriction member and the mounting of the attachment member can be performed from the front side of the device, the workability can be improved.

(F) In the recording device described in (A), the restriction member includes the first engagement section that is capable to engage with the first engaged section belonging to the movement section, and the second engagement section that is capable to engage with the second engaged section belonging to the mount section, wherein a length from the first engagement section to the second engagement section may be the same as a length from the first engaged section to the second engaged section.

According to this configuration, the length from the first engagement section to the second engagement section is the same as the length from the first engaged section to the second engaged section. Therefore, the operator can engage the second engagement section with the second engaged section by rotating the restriction member, which has engaged the first engagement section with the first engaged section, about the first engaged section. Therefore, since the restriction member can be easily mounted, workability can be improved.

(G) In the recording device described in (B), the restriction member includes a first engagement section configured to engage with a first engaged section provided on the frame and a second engagement section configured to engage with a second engaged section of the mount section, wherein a length from the first engagement section to the second engagement section is the same as a length from the first engaged section to the second engaged section. According to this configuration, the same effect as the recording device above described can be achieved.

(H) In the recording device described in (F) or (G), the attachment member is mounted on the mount section by moving along a first direction, the second engagement section has an engagement claw configured to engage with the second engaged section, and the second direction in which the engagement claw is disengaged from the second engaged section may be different direction from the first direction.

According to this configuration, the direction in which the engagement between the second engagement section and the second engaged section is released is different direction from the direction in which the attachment member is mounted. Therefore, even when the attachment member moving in the first direction comes into contact with the restriction member, it is possible to reduce the risk that the restricted state of the restriction member is released.

(I) In the recording device described in (A) to (H), it includes the storage section configured to store the restriction member, wherein the storage section may be provided at a cassette that stores a medium.

According to this configuration, the restriction member can be housed in the storage section. Therefore, when the restriction member is not in use, restriction member can be stored in the storage section, thus reducing the risk of loss. The storage section is provided at the cassette that stores the medium. Therefore, since the operator can easily access the storage section, workability can be improved.

(J) In the recording device described in (I), the cassette includes a placement section on which the medium is placed, and the storage section may be provided at a position different from the placement section.

According to this configuration, the storage section is provided at a position different from the placement section. Therefore, it is possible to reduce the risk that the restriction member accommodated in the storage section hits the medium placed on the placement section.

(K) In the recording device described in (I) or (J), the storage section includes a recess section provided on the bottom surface of the cassette and a holding claw capable to elastic deform, and the restriction member may engage with the holding claw.

According to this configuration, the storage section is provided on the bottom surface of the cassette. For that reason, the restriction member accommodated in the storage section is less likely to be noticed by the user, so that it is possible to reduce the risk that the user erroneously uses the restriction member. The restriction member engages with the holding claw. Therefore, for example, even in a case where an impact is applied when the cassette is inserted and removed, it is possible to reduce the risk that the restriction member drops out from the storage section.

(L) In the recording device described in (B), the displacement member includes an engaged section configured to engage with an engagement section of the restriction member and by engaging the engagement section with the engaged section, the restriction member displaces the displacement member to the restricting position.

According to this configuration, the restriction member displaces the displacement member to the restricting position by engaging the engagement section with the engaged section. Therefore, the movement of the movement section in the movement direction can be regulated with a simple configuration.

(M) In the recording device described in (B), (G) or (L), the displacement member may extend in a direction along the direction of the longitudinal direction of the movement section.

For example, in a case where the length of the movement section is long, there is a risk that the movement section is inclined even when the movement of a part of the movement section is restricted. In this regard, according to this configuration, the displacement member extends in a direction along the longitudinal direction of the movement section. Therefore, the displacement member can restrict the movement of the movement section in the entire section in longitudinal direction. Therefore, it is possible to stably restrict the movement of the movement section.

(N) In the recording device described in (A) to (M), the movement section is a liquid ejection section configured to record on a medium by ejecting liquid from a nozzle and the attachment member may be a liquid accommodation body configured to contain liquid.

According to this configuration, the movement section is the liquid ejection section. The attachment member is the liquid accommodation body. In other words, it is necessary to mount the attachment member in order for the liquid ejection section to perform recording by ejecting liquid. Since the attachment member cannot be mounted without removing the restriction member, it is possible to reduce the risk of being used while the restriction member is mounted.

(O) The recording device described in (N) includes a cap capable to cap the liquid ejection section by covering the nozzle, wherein the restriction member in the restricted state may restrict movement of the liquid ejection section capped by the cap.

According to this configuration, the restriction member restricts the movement of the liquid ejection section in a state where the liquid ejection section is capped. Therefore, it is possible to reduce the risk that the nozzle will dry out even during transportation.

(P) In the recording device described in (N) or (O), the liquid ejection section is a line head, the mounting space is a space extending in a direction along a longitudinal direction of the liquid ejection section, and the restriction member restricts the central section of the liquid ejection section in the longitudinal direction.

According to this configuration, the liquid ejection section is a line head. The restriction member restricts the central section of the liquid ejection section in the longitudinal direction. Therefore, for example, compared to a case where the end of the liquid ejection section is restricted, it is possible to effectively suppress the movement of the liquid ejection section.

(Q) A recording device includes a movement section configured to move in a movement direction; a mount section including a mounting space in which an attachment member that was inserted from an opening section is attachable; a fixed frame; and a restriction member that is attachable to and detachable from the frame and that is configured to restrict movement of the movement section in the movement direction by being attached to the frame; wherein the restriction member is positioned in the mounting space when the restriction member is in a restricted state in which the restriction member restricts movement of the movement section. According to this configuration, the same effect as the recording device above described can be achieved.

(R) A recording device includes a movement section configured to move in a movement direction; a mount section including a mounting space in which an attachment member that was inserted from an opening section is attachable; a fixed frame; the restriction member that is attachable to and detachable from the frame, and a displacement member configured to be displaced to the restricting position that the displacement member restricts movement of the movement section in movement direction by mounting the restriction member to the frame, wherein the restriction member is positioned in the mounting space when the restriction member is the restricted state that the restriction member set the displacement member on the restricting position.

What is claimed is:

1. A recording device comprising:
a movement section configured to move in a movement direction;
a mount section including a mounting space in which an attachment member that was inserted from an opening section is attachable;
a fixed frame;
a restriction member that is attachable to and detachable from the frame and that is configured to restrict movement of the movement section in the movement direction by being attached to the frame; and
a displacement member configured to, by the restriction member being attached to the frame, be displaced to a restricting position at which the displacement member, together with the restriction member, restricts movement of the movement section in movement direction, wherein
the restriction member is positioned in the mounting space when the restriction member is in a restricted state in which the restriction member restricts movement of the movement section.

2. The recording device according to claim 1, wherein
at least a portion of the attachment member is positioned outside the mounting space from the opening section when the attachment member is inserted into the mount section in the restricted state.

3. The recording device according to claim 2, further comprising:
a cover configured to be displaced between a closed state in which the cover covers the opening section and an open state in which the cover does not cover the opening section.

4. The recording device according to claim 3, wherein
the opening section opens to a front surface of the device.

5. The recording device according to claim 1, wherein
the restriction member includes
a first engagement section configured to engage with a first engaged section that positioned on the frame and
a second engagement section configured to engage with a second engaged section of the mount section and
a length from the first engagement section to the second engagement section is the same as a length from the first engaged section to the second engaged section.

6. The recording device according to claim 5, wherein
the attachment member is mounted on the mount section by moving along a first direction,
the second engagement section has an engagement claw configured to engage with the second engaged section, and
a second direction in which the engagement claw is disengaged from the second engaged section is a direction different from the first direction.

7. The recording device according to claim 1, further comprising:
the storage section configured to store the restriction member, wherein
the storage section is provided in a cassette that stores a medium.

8. The recording device according to claim 7, wherein
the cassette includes a placement section on which the medium is placed and
the storage section is provided at a position different from the placement section.

9. The recording device according to claim 8, wherein
the storage section includes
a recess section provided in a bottom surface of the cassette and
elastically deformable holding claws and
the restriction member is engaged with the holding claw.

10. The recording device according to claim 1, wherein
the displacement member includes an engaged section configured to engage with an engagement section of the restriction member and
the restriction member displaces the displacement member to the restricting position by the engagement section engaging with the engaged section.

11. The recording device according to claim 1, wherein
the displacement member extends in a direction along a longitudinal direction of the movement section.

12. The recording device according to claim 1, wherein
the movement section is a liquid ejection section configured to record on a medium by ejecting liquid from a nozzle and
the attachment member is a liquid accommodation body configured to contain liquid.

13. The recording device according to claim 12, further comprising:
a cap configured to cap the liquid ejection section by covering the nozzle, wherein
the restriction member in the restricted state restricts movement of the liquid ejection section capped by the cap.

14. The recording device according to claim 12, wherein
the liquid ejection section is a line head,
the mounting space is a space extending in a direction along a longitudinal direction of the liquid ejection section, and
the restriction member restricts a central section of the liquid ejection section in the longitudinal direction.
